(19) United States
(12) Patent Application Publication
(10) Pub. No.: US 2009/0223947 A1
(43) Pub. Date: Sep. 10, 2009

(54) CERAMIC HEATING ELEMENT, CERAMIC HEATING ELEMENT WITH TERMINALS, AND CERAMIC HEATING TUBE

(76) Inventor: Pai-her Mou, Tainan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/395,819

(22) Filed: Mar. 2, 2009

(30) Foreign Application Priority Data
Mar. 5, 2008 (TW) 097203713

(51) Int. Cl. H05B 3/03; B32B 18/00

(52) U.S. Cl. 219/539; 428/337

(57) ABSTRACT

The present invention relates to a ceramic heating element, a ceramic heating element with terminals, and a ceramic heating tube, which consists of a mixture of china clay powder in a volume of 25% to 75% and conductive graphite powder in a volume of 25% to 75%, a vitreous insulation layer, and an enamel layer. The mixture is sintered to form the vitreous insulation layer and the enamel layer from inside to outside. Inside the vitreous insulation layer is the mixture of the china clay powder and the conductive graphite powder which are not vitrified to form a conductive layer. The ceramic heating element has two ends connected with a first terminal and a second terminal to form a ceramic heating element having terminal or a ceramic heating tube for heating.

### BACKGROUND OF THE INVENTION

1. Field of the Invention

The present invention relates to a ceramic heating element, a ceramic heating element with terminals, and a ceramic heating tube, and more particular to one consisting of a mixture of china clay powder in a volume of 25% to 75% and conductive graphite powder in a volume of 25% to 75%, a vitreous insulation layer, and an enamel layer, the mixture being sintered to form the vitreous insulation layer and the enamel layer from inside to outside, inside the vitreous insulation layer being the mixture of the china clay powder and the conductive graphite powder which are not vitrified to form a conductive layer, the ceramic heating element having two ends connected with a first terminal and a second terminal to conduct electricity for heating.

2. Description of the Prior Art

Taiwanese patent No. M326442 titled “a graphite electric conducting ceramic with acid cleaning sink” discloses an electric heating apparatus which uses graphite as a basic material. The graphite is covered with a layer of macromolecule ceramic material. The graphite is provided with two conductive terminals to transmit electricity for producing heat. This apparatus has a few shortcomings:
1. the layer of macromolecule ceramic material may be damaged when encountering an abrupt temperature rise because the macromolecule ceramic material and the graphite have different coefficient of heat expansion, and they may be exploded;
2. the character of graphite can endure heat conducting, but it lacks of coefficient of resistant and power, in particular its design of electrode and graphite must be careful to prevent the electrode from overheating to be burned out;
3. the electric circuit arrangement is not perfect, both wires receive input from the same terminal of the electric heating apparatus, the input terminal of the graphite is the only terminal to conduct electricity, thus, the temperature will be uneven, furthermore, the graphite has a low resistance coefficient which is not appropriate to be operated under a high electric current, or it will be ended up with short circuit or burned out;
4. the ceramic surface is exposed outwardly without any cover or protection, water or any other liquid will penetrate through its pores into the graphite layer to cause electric leakage; and
5. the ceramic material has pores, making it not appropriate to be placed under the environment of a strong acid or alkali.

Taiwanese patent publication No. 441219 titled “a ceramic heating tube” disclosed a method for making a ceramic heating tube, which consists of barium carbonate in a volume of 10%, zirconium silicate in a volume of 40%, magnesia metal compound in a volume of 30%, UK clay in a volume of 10%, and New Zealand kaolin in a volume of 10%. The mixture is dried and grinded to be in the form of powder. A heating wire is placed in a mold, and then the mixed powder is poured into the mold for forming, which is then placed into a furnace to heat with a temperature over 1200 degrees Celsius, thus a ceramic heating tube is formed. The heating wire is exposed outwardly, which decreases the heating power. This design is not perfect.

### SUMMARY OF THE INVENTION

According to a first aspect of the present invention, there is provided a ceramic heating element consisting of a mixture of china clay powder in a volume of 25% to 75% and conductive graphite powder in a volume of 25% to 75%, a vitreous insulation layer, and an enamel layer, the mixture being sintered to form the vitreous insulation layer and the enamel layer from inside to outside, inside the vitreous insulation layer being the mixture of the china clay powder and the conductive graphite powder which are not vitrified.

Preferably, the vitreous insulation layer has a thickness of 0.5 mm to 3 mm.

Preferably, the china clay powder is adjusted to a volume of 45% to 60%; the conductive graphite powder is adjusted to a volume of 30% to 40%, and the mixture is added with one or a compound of silicone power, magnetite powder and carborundum power in a volume of 10% to 15%.

According to a second aspect of the present invention, there is provided ceramic heating element having terminal consisting of a mixture of china clay powder in a volume of 25% to 75% and conductive graphite powder in a volume of 25% to 75%, a vitreous insulation layer, and an enamel layer, the mixture being sintered to form the vitreous insulation layer and the enamel layer from inside to outside, inside the vitreous insulation layer being the mixture of the china clay powder and the conductive graphite powder which are not vitrified, the ceramic heating element having two ends, the vitreous insulation layer and the enamel layer of the two ends being cut out to form two connecting portions, respectively, for connecting with a first terminal and a second terminal.

Preferably, the two connecting portions are disposed at relative far ends of the ceramic heating element.

Preferably, the first terminal has a first fixed end and a first free end and the second terminal has a second fixed end and a second free end, the first fixed end and the second fixed end being connected with the two connecting portions, the first free end and the second free end being exposed outwardly.

Preferably, the two connecting portions are coated with conductive gold ointment, and the first fixed end and the second fixed end are provided with platinum contact points.

Preferably, each of the junction of the first fixed end and a relative connecting portion and the junction of the second fixed end and a relative connecting portion has an outer edge covered with a ceramic covering, the ceramic covering having a covering enamel layer at an outer surface thereof, the covering enamel layer being adapted to seal a contact point of the enamel layer of the ceramic heating element and the ceramic covering, a contact point of the ceramic covering and the first terminal, and a contact point of the ceramic covering and the second terminal.

Preferably, the china clay powder is adjusted to a volume of 45% to 60%; the conductive graphite powder is adjusted to a volume of 30% to 40%, and the mixture is added with one or a compound of silicone power, magnetite powder and carborundum power in a volume of 10% to 15%.

According to a third aspect of the present invention, there is provided a ceramic heating tube consisting of a mixture of china clay powder in a volume of 25% to 75% and conductive graphite powder in a volume of 25% to 75%, a vitreous insulation layer, and an enamel layer, the mixture being sintered have a tube shape formed with the vitreous insulation layer and the enamel layer on inner and outer surfaces of the tube, inside the vitreous insulation layer being the mixture of the china clay powder and the conductive graphite powder which are not vitrified, the ceramic heating tube having two relative far ends connected with a first terminal and a second terminal, the first terminal and the second terminal being capable of conducting electricity.

Preferably, the vitreous insulation layer and the enamel layer of the two ends of the ceramic heating tube are cut out to form two connecting portions, respectively, for connecting with the first terminal and the second terminal.

Preferably, the two connecting portions are coated with conductive gold ointment, the first terminal and the second terminal are provided with platinum contact points, and the first terminal and the second terminal are connected with a bolt and a conductive wire.

Preferably, each of the junction of the first terminal and a relative connecting portion and the junction of the second terminal and a relative connecting portion has an outer edge covered with a ceramic covering, the ceramic covering having a covering enamel layer at an outer surface thereof, the covering enamel layer being adapted to seal a contact point of the enamel layer of the ceramic heating element and the ceramic covering, a contact point of the ceramic covering and the first terminal, and a contact point of the ceramic covering and the second terminal.

Preferably, the ceramic heating tube is shaped in a continuous curving tube.

Preferably, the china clay powder is adjusted to a volume of 45% to 60%; the conductive graphite powder is adjusted to a volume of 30% to 40%, and the mixture is added with one or a compound of silicone power, magnetite powder and carborundum power in a volume of 10% to 15%.

The present invention has the following advantages:

1. After conducting electricity, it is able to work under the temperature of above 650 degrees Celsius.

2. With the enamel layer and the ceramic covering, it provides a good insulation effect, especially to prevent liquid from penetrating into the present invention. Therefore, the present invention is able to be used in various circumstances.

3. The present invention is endurable to high temperature or corrosion circumstance, and the terminals are not oxidized and damaged easily.

4. The present invention decreases the cost of manufacture and provides a better electric conductivity by using the gold ointment, thus it is durable and is the best replacement to a traditional heating wire or heating tube.

5. The present invention is formed by mixing and sintering china clay powder and conductive graphite powder so that it is able to work at a high temperature circumstance without being deformed or even exploded.

6. The present invention may be used to heat water for producing steam, or to warm up an indoor facility as a heater, or to supply heated air to a fuel reformer; or to function as a heat source of a boiler for producing steam as a power output, or to function as a heating element of household electric appliances.

### BRIEF DESCRIPTION OF THE DRAWINGS

FIG. 1 is a cross-sectional view of a ceramic heating element according to a first embodiment of the present invention;

FIG. 2 is a cross-sectional view of a ceramic heating element having terminals according to a second embodiment of the present invention;

FIG. 3 is a cross-sectional view of a ceramic heating element having terminals according to a third embodiment of the present invention;

FIG. 4 is a schematic view of a ceramic heating tube according to a fourth embodiment of the present invention; and

FIG. 5 is a cross-sectional view of the ceramic heating tube according to the fourth embodiment of the present invention.

### DETAILED DESCRIPTION OF THE PREFERRED EMBODIMENTS

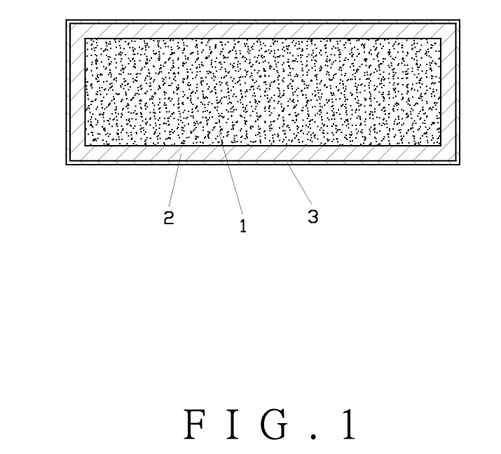

Referring to FIG. 1, a ceramic heating element according to a first embodiment of the present invention consists of a mixture 1 of china clay powder in a volume of 25% to 75% and conductive graphite powder in a volume of 25% to 75%, a vitreous insulation layer 2, and an enamel layer 3. The mixture 1 is sintered to form the vitreous insulation layer 2 and the enamel layer 3 in a predetermined shape which may be in a square, an English letter U, or a stick shape. The vitreous insulation layer 2 has a thickness of 0.5 mm to 3 mm. Inside the vitreous insulation layer 2 is the mixture of the china clay powder and the conductive graphite powder which are not vitrified to form a conductive layer.

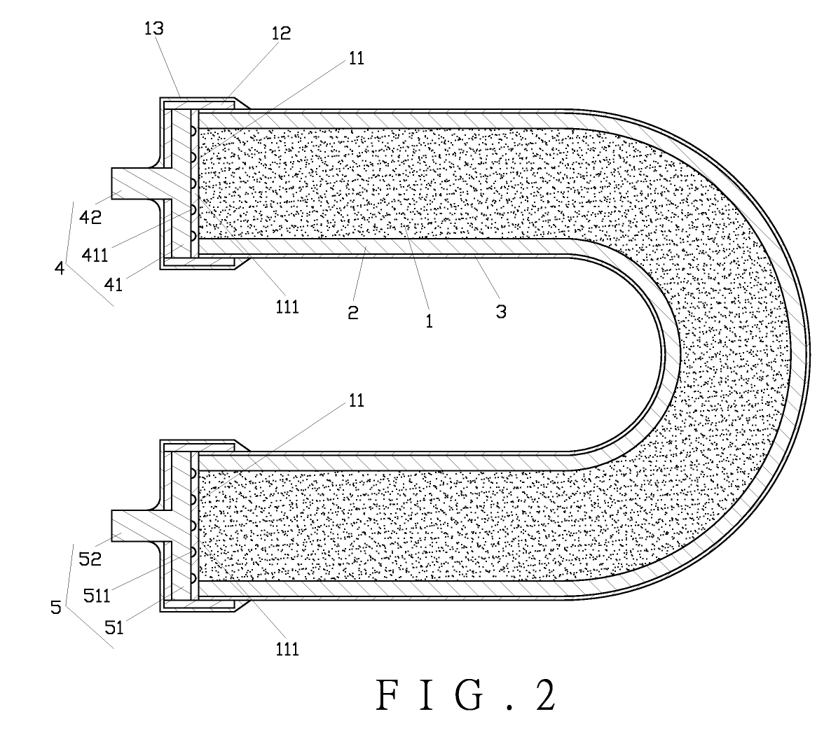

Referring to FIG. 2, a ceramic heating element with terminals according to a second embodiment of the present invention consists of a mixture 1 of china clay powder in a volume of 25% to 75% and conductive graphite powder in a volume of 25% to 75%, a vitreous insulation layer 2, and an enamel layer 3. The mixture 1 is sintered to form the vitreous insulation layer 2 and the enamel layer 3 in an English letter U shape. The vitreous insulation layer 2 has a thickness of 0.5 mm to 3 mm. Inside the vitreous insulation layer 2 is the mixture of the china clay powder and the conductive graphite powder which are not vitrified to form a conductive layer. The ceramic heating element has two relative far ends. The vitreous insulation layer 2 and the enamel layer 3 of the two ends are rubbed or cut out to form a connecting portion 11 for exposing the mixture 1 inside the vitreous insulation layer 2. The connecting portion 11 is coated with conductive gold ointment 111. The connecting portions 11 at the two ends of the ceramic heating element are connected with a first terminal 4 and a second terminal 5, respectively. The first terminal 4 has a first fixed end 41 and a first free end 42. The second terminal 5 has a second fixed end 51 and a second free end 52. The first fixed end 41 and the second fixed end 51 are provided with platinum contact points 411 and 511, respectively, to be connected with the gold ointment 111 on the connecting portions 11. Both the junction of the first fixed end 41 and the connecting portion 11 and the junction of the second fixed end 51 and the connecting portion 11 have an outer edge to be sintered again to form a ceramic covering 12 at a temperature of 900 to 1060 degrees Celsius. The ceramic covering 12 has a covering enamel layer 13 at an outer surface thereof. The covering enamel layer 13 is adapted to seal the contact point of the enamel layer 3 of the ceramic heating element and the ceramic covering 12, the contact point of the ceramic covering 12 and the first terminal 4, and the contact point of the ceramic covering 12 and the second terminal 5. The first free end 42 of the first terminal 4 and the second free end 52 of the second terminal 5 are exposed outwardly for connecting with a power supply (not shown in the drawings).

To operate the second embodiment of the present invention, either a direct current or an alternate current is supplied to the ceramic heating element so that the mixture 1 is able to conduct electricity and heat because the mixture 1 includes the conductive graphite powder. The vitreous insulation layer 2 keeps the conductive function properly. The enamel layer 3 prevents water or other liquid from penetrating into the ceramic heating element so that the ceramic heating element may be working in an environment surrounded by liquid.

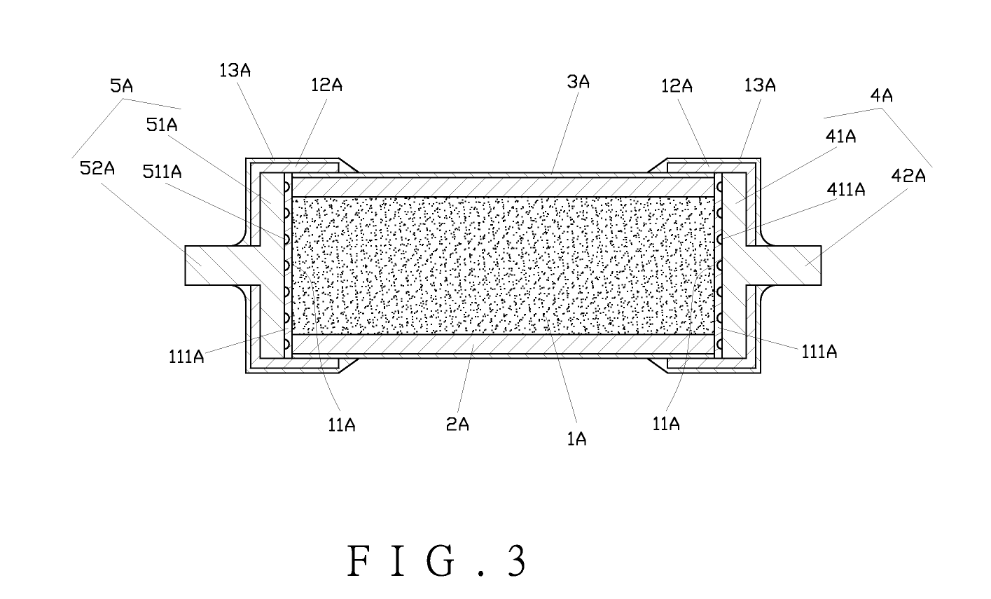

Referring to FIG. 3, a ceramic heating element with terminals according to a third embodiment of the present invention consists of a mixture 1A of china clay powder in a volume of 25% to 75% and conductive graphite powder in a volume of 25% to 75%, a vitreous insulation layer 2A, and an enamel layer 3A. The mixture 1A is sintered to form the vitreous insulation layer 2A and the enamel layer 3A in a block shape. The vitreous insulation layer 2A has a thickness of 0.5 mm to 3 mm. Inside the vitreous insulation layer 2A is the mixture of the china clay powder and the conductive graphite powder which are not vitrified to form a conductive layer. The ceramic heating element has two relative far ends. The vitreous insulation layer 2A and the enamel layer 3A of the two ends are rubbed or cut out to form a connecting portion 11A for exposing the mixture 1A inside the vitreous insulation layer 2A. The connecting portion 11A is coated with conductive gold ointment 111A. The connecting portions 11A at the two ends of the ceramic heating element are connected with a first terminal 4A and a second terminal 5A, respectively. The first terminal 4A has a first fixed end 41 and a first free end 42A. The second terminal 5A has a second fixed end 51A and a second free end 52A. The first fixed end 41A and the second fixed end 51A are provided with platinum contact points 411A and 511A, respectively, to be connected with the gold ointment 11A on the connecting portions 11A. Both the junction of the first fixed end 41A and the connecting portion 11A and the junction of the second fixed end 51A and the connecting portion 11A have an outer edge to be sintered again to form a ceramic covering 12A at a temperature of 900 to 1060 degrees Celsius. The ceramic covering 12A has a covering enamel layer 13A at an outer surface thereof. The covering enamel layer 13A is adapted to seal the contact point of the enamel layer 3A of the ceramic heating element and the ceramic covering 12A, the contact point of the ceramic covering 12A and the first terminal 4A, and the contact point of the ceramic covering 12A and the second terminal 5A. The first free end 42A of the first terminal 4A and the second free end 52A of the second terminal 5A are exposed outwardly for connecting with a direct current or an alternate current (not shown in the drawings).

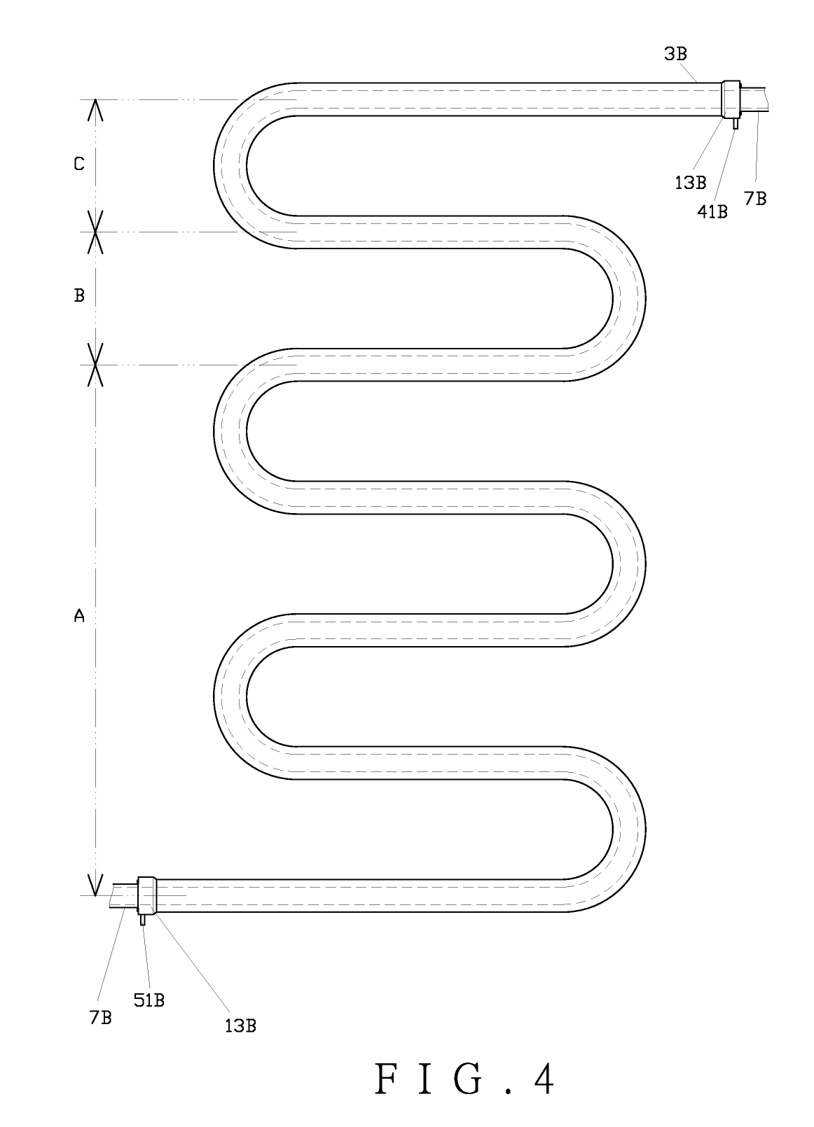

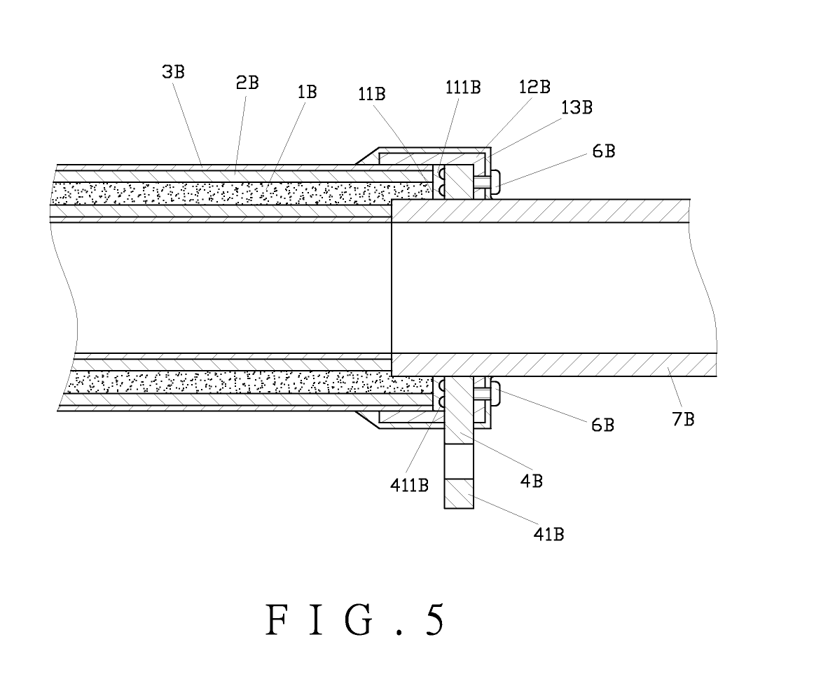

Referring to FIGS. 4 and 5, a ceramic heating tube according to a fourth embodiment of the present invention consists of a mixture 1B of china clay powder in a volume of 25% to 75% and conductive graphite powder in a volume of 25% to 75%, a vitreous insulation layer 2B, and an enamel layer 3B. The mixture 1B is sintered to have a tube shape formed with the vitreous insulation layer 2B and the enamel layer 3B on inner and outer surfaces of the tube. Inside the vitreous insulation layer 2B is the mixture of the china clay powder and the conductive graphite powder which are not vitrified to form a conductive layer. The ceramic heating tube has two relative far ends each provided with a connecting portion 11B. The connecting portion 11B is coated with conductive gold ointment 111B. The connecting portions 11B are connected with a first terminal 4B and a second terminal (not shown in the drawings, having the identical configuration of the first terminal 4B), respectively. The first terminal 4B and the second terminal in this embodiment are designed in a numerical eight (8) shape. The first terminal 4B and the second terminal are provided with platinum contact points 411B, respectively, to be connected with the gold ointment 111B. Both the junction of the first terminal 4B and the connecting portion 11B and the junction of the second terminal and the connecting portion 11B have an outer edge to be sintered again to form a ceramic covering 12B. The ceramic covering 12B has a covering enamel layer 13B at an outer surface thereof. The covering enamel layer 13B is adapted to seal the contact point of the enamel layer 3B of the ceramic heating tube and the ceramic covering 12B, the contact point of the ceramic covering 12B and the first terminal 4B, and the contact point of the ceramic covering 12B and the second terminal. The ceramic covering 12B is formed with a threaded hole for insertion of a bolt 6B so as to fasten the first terminal 4B towards the golden ointment 111B. The ceramic covering 12B is formed with a through hole for an electric wire 41B of the first terminal 4B as well as an electric wire 51B of the second terminal 5B to extend therefrom.

To operate the present invention, as shown in FIGS. 4 and 5, the ceramic heating tube may be shaped in a continuous curving tube and has liquid or air stored in the tube. The two ends of the tube are connected with other ceramic tubes 7B. The continuous curving tube is partitioned into a lower section A, a middle section B, and an upper section C. When the electric wire 41B of the first terminal 4B and the electric wire 51B of the second terminal are connected with electricity, respectively, the operation will have the following types:
1. pouring water into the tube to fill up the lower section A and maintaining the water at the level of the lower section A: when the ceramic heating tube is heated, the lower section A will become a heating section to heat the water; the middle section B will be filled with steam after the water is heated; and the upper section C will be filled with high temperature steam;
2. pouring water into the tube and maintaining the water at the level of the upper section C of the tube: when the water is heated through the ceramic heating tube, the water will be functioned like a hot water supply system; and
3. pumping air into the tube to be heated with the ceramic heating tube, forming a heater supply system.

All the aforesaid embodiments, the proportion of the mixture may be adjusted to the china clay powder in an volume of 45% to 60%, the conductive graphite powder of 30% to 40%, and added with one or a compound of silicone power, magnetite powder and carborundum power (SiC) in a volume of 10% to 15% for increasing its density and resistance coefficient. The proportion may be adjusted depending upon the size and shape of the ceramic heating tube, such as a stick, a block, a continuous curving tube, as well as the thickness, length, etc. of the tube for calculating the required voltage and ampere.

What is claimed is:

1. A ceramic heating element, consisting of a mixture of china clay powder in a volume of 25% to 75% and conductive graphite powder in a volume of 25% to 75%, a vitreous insulation layer, and an enamel layer, the mixture being sintered to form the vitreous insulation layer and the enamel layer from inside to outside, inside the vitreous insulation layer being the mixture of the china clay powder and the conductive graphite powder which are not vitrified.

2. The ceramic heating element as claimed in claim 1, wherein the vitreous insulation layer has a thickness of 0.5 mm to 3 mm.

3. The ceramic heating element as claimed in claim 1, wherein the china clay powder is adjusted to a volume of 45% to 60%; the conductive graphite powder is adjusted to a volume of 30% to 40%, and the mixture is added with one or a compound of silicone power, magnetite powder and carborundum power in a volume of 10% to 15%.

4. A ceramic heating element having terminals, consisting of a mixture of china clay powder in a volume of 25% to 75% and conductive graphite powder in a volume of 25% to 75%, a vitreous insulation layer, and an enamel layer, the mixture being sintered to form the vitreous insulation layer and the enamel layer from inside to outside, inside the vitreous insulation layer being the mixture of the china clay powder and the conductive graphite powder which are not vitrified, the ceramic heating element having two ends, the vitreous insulation layer and the enamel layer of the two ends being cut out to form two connecting portions, respectively, for connecting with a first terminal and a second terminal.

5. The ceramic heating element having terminals as claimed in claim 4, wherein the two connecting portions are disposed at relative far ends of the ceramic heating element.

6. The ceramic heating element having terminals as claimed in claim 4, wherein the first terminal has a first fixed end and a first free end and the second terminal has a second fixed end and a second free end, the first fixed end and the second fixed end being connected with the two connecting portions, the first free end and the second free end being exposed outwardly.

7. The ceramic heating element having terminals as claimed in claim 6, wherein each of the junction of the first fixed end and a relative connecting portion and the junction of the second fixed end and a relative connecting portion has an outer edge covered with a ceramic covering, the ceramic covering having a covering enamel layer at an outer surface thereof, the covering enamel layer being adapted to seal a contact point of the enamel layer of the ceramic heating element and the ceramic covering, a contact point of the ceramic covering and the first terminal, and a contact point of the ceramic covering and the second terminal.

8. The ceramic heating element having terminals as claimed in claim 4, wherein the two connecting portions are coated with conductive gold ointment, and the first fixed end and the second fixed end are provided with platinum contact points.

9. The ceramic heating element having terminals as claimed in claim 8, wherein each of the junction of the first fixed end and a relative connecting portion and the junction of the second fixed end and a relative connecting portion has an outer edge covered with a ceramic covering, the ceramic covering having a covering enamel layer at an outer surface thereof, the covering enamel layer being adapted to seal a contact point of the enamel layer of the ceramic heating element and the ceramic covering, a contact point of the ceramic covering and the first terminal, and a contact point of the ceramic covering and the second terminal.

10. The ceramic heating element having terminals as claimed in claim 4, wherein the china clay powder is adjusted to a volume of 45% to 60%; the conductive graphite powder is adjusted to a volume of 30% to 40%, and the mixture is added with one or a compound of silicone power, magnetite powder and carborundum power in a volume of 10% to 15%.

11. A ceramic heating tube, consisting of a mixture of china clay powder in a volume of 25% to 75% and conductive graphite powder in a volume of 25% to 75%, a vitreous insulation layer, and an enamel layer, the mixture being sintered have a tube shape formed with the vitreous insulation layer and the enamel layer on inner and outer surfaces of the tube, inside the vitreous insulation layer being the mixture of the china clay powder and the conductive graphite powder which are not vitrified, the ceramic heating tube having two relative far ends connected with a first terminal and a second terminal, the first terminal and the second terminal being capable of conducting electricity.

12. The ceramic heating tube as claimed in claim 11, wherein the vitreous insulation layer and the enamel layer of the two ends of the ceramic heating tube are cut out to form two connecting portions, respectively, for connecting with the first terminal and the second terminal.

13. The ceramic heating tube as claimed in claim 12, wherein each of the junction of the first terminal and a relative connecting portion and the junction of the second terminal and a relative connecting portion has an outer edge covered with a ceramic covering, the ceramic covering having a covering enamel layer at an outer surface thereof, the covering enamel layer being adapted to seal a contact point of the enamel layer of the ceramic heating element and the ceramic covering, a contact point of the ceramic covering and the first terminal, and a contact point of the ceramic covering and the second terminal.

14. The ceramic heating tube as claimed in claim 12, wherein the two connecting portions are coated with conductive gold ointment, and the first terminal and the second terminal are provided with platinum contact points.

15. The ceramic heating tube as claimed in claim 14, wherein each of the junction of the first terminal and a relative connecting portion and the junction of the second terminal and a relative connecting portion has an outer edge covered with a ceramic covering, the ceramic covering having a covering enamel layer at an outer surface thereof, the covering enamel layer being adapted to seal a contact point of the enamel layer of the ceramic heating element and the ceramic covering, a contact point of the ceramic covering and the first terminal, and a contact point of the ceramic covering and the second terminal.

16. The ceramic heating tube as claimed in claim 11, wherein the ceramic heating tube is shaped in a continuous curving tube.

17. The ceramic heating tube as claimed in claim 11, wherein the china clay powder is adjusted to a volume of 45% to 60%; the conductive graphite powder is adjusted to a volume of 30% to 40%, and the mixture is added with one or a compound of silicone power, magnetite powder and carborundum power in a volume of 10% to 15%.
